(19) United States
(12) Patent Application Publication
(10) Pub. No.: US 2006/0059093 A1
(43) Pub. Date: Mar. 16, 2006

(54) Data processing apparatus, data processing method, and computer program

(75) Inventors: Yoichi Takaragi, Yokohama-shi (JP); Masao Hayashi, Yokohama-shi (JP); Kentaro Saito, Kawasaki-shi (JP); Akio Ito, Yokohama-shi (JP); Tadashi Hagiuda, Yokohama-shi (JP); Kazuhiro Sakaguchi, Yokosuka-shi (JP)

Correspondence Address: Canon U.S.A. Inc.;Intellectual Property Division, 15975 Alton Parkway, Irvine, CA, 92618-3731, US

(73) Assignee: Canon Kabushiki Kaisha, Ohta-ku (JP)

(21) Appl. No.: 11/217,272

(22) Filed: Sep. 1, 2005

(30) Foreign Application Priority Data
Sep. 14, 2004 (JP) 2004-266822

(51) Int. Cl. H04L 9/00

(52) U.S. Cl. 705/51

(57) ABSTRACT

A data processing apparatus includes a position-information acquisition unit adapted to acquire position information of the data processing apparatus, a key-generation unit adapted to generate a key dependent on the position information acquired by the position-information acquisition unit, an encryption unit adapted to generate encrypted data by encrypting data using the key generated by the key-generation unit, a recording unit adapted to record the encrypted data onto an external recording medium, and a decryption unit adapted to decrypt the encrypted data recorded onto the external recording medium by using a key that is dependent on the position information acquired by the position-information acquisition unit and that is generated by the key-generation unit.

### BACKGROUND OF THE INVENTION

1. Field of the Invention

The present invention relates to a data processing apparatus, a data processing method, and a computer program.

2. Description of the Related Art

In the advanced information world of today, technologies for ensuring the confidentiality of information and preventing the information from being improperly used are of extreme importance. For example, according to the technologies disclosed in Japanese Patent Laid-Open No. 2002-74836 and Japanese Patent Laid-Open No. 2003-18539, a region code is stored in a mobile external recording medium such as a digital versatile disk (DVD) or the like and a reproduction device configured to reproduce the external recording medium. The region code is used so that the data stored in the external recording medium is reproduced only in a predetermined region.

More specifically, where the DVD is set into the reproduction device, the reproduction device determines whether or not the region code stored therein agrees with the region code stored in the DVD. When the region codes agree with each other, the reproduction device decrypts and reproduces the data stored in the DVD.

According to the above-described technologies, however, the data stored in the mobile external recording medium can be reproduced so long as the region code stored in the mobile external recording medium agrees with that stored in the reproduction device, which means that the data stored in the external recording medium can be reproduced by another reproduction device installed at any place outside a region limited by the region code.

In other words, even though the external recording medium stores a region code that permits data to be reproduced only in country A, the data can be reproduced in country B by using a reproduction device storing the same region code as that stored in the external recording medium. Thus, according to the known technologies, it has been difficult to reliably limit the place where data stored in the external recording medium is reproduced.

### SUMMARY OF THE INVENTION

Accordingly, the present invention allows limiting the place where the data stored in the external recording medium is reproduced in the most reliable manner as possible.

In accordance with an aspect of the present invention, a data processing apparatus includes a position-information acquisition unit adapted to acquire position information of the data processing apparatus, a key-generation unit adapted to generate a key dependent on the position information acquired by the position-information acquisition unit, an encryption unit adapted to generate encrypted data by encrypting the data using the key generated by the key-generation unit, a recording unit adapted to record the encrypted data onto an external recording medium, and a decryption unit adapted to decrypt the encrypted data recorded onto the external recording medium by using a key that is dependent on the position information acquired by the position-information acquisition unit and that is generated by the key-generation unit.

In accordance with another aspect of the present invention, a data processing method includes steps of receiving a record instruction for recording data onto an external recording medium, acquiring first position information of a data processing apparatus based on the record instruction, generating a first key dependent on the first position information, generating encrypted data by encrypting the data using the first key, recording the encrypted data onto the external recording medium, receiving a reproduction instruction for reproducing the encrypted data recorded onto the external recording medium, acquiring second position information of the data processing apparatus according to the reproduction instruction, generating a second key dependent on the second position information, and decrypting the encrypted data recorded onto the external recording medium using the second key.

In accordance with another aspect of the present invention, a data processing method includes steps of detecting movement of a data processing apparatus, acquiring position information of the data processing apparatus when movement of the data processing apparatus is detected, generating a key dependent on the position information, holding the key, encrypting the data by using the key, recording the encrypted data onto the external recording medium, and decrypting the encrypted data recorded onto the external recording medium by using the held key.

In accordance with yet another aspect of the present invention, a computer program is configured to make a computer execute either of the above-described methods.

Further features of the present invention will become apparent from the following description of exemplary embodiments with reference to the attached drawings.

### BRIEF DESCRIPTION OF THE DRAWINGS

FIG. 1 shows an example configuration of an image forming system according to a first embodiment of the present invention.

FIG. 2 shows an example internal processing configuration of a multi function peripheral (MFP) according to the first embodiment.

FIG. 3 is a block diagram showing the configuration of an example core unit according to the first embodiment.

FIG. 4 is a block diagram showing an example functional configuration of a position-control server and the MFP.

FIG. 5 shows an example functional configuration of a DVD unit in the MFP according to the first embodiment.

FIG. 6 shows an example configuration of the DVD unit in the MFP according to the first embodiment.

FIG. 7 is a flowchart illustrating example processing performed by the position-control server and the MFP according to the first embodiment, where the processing is performed for writing data onto an external recording medium (DVD).

FIG. 8 is a flowchart illustrating example processing performed by the position-control server and the MFP according to the first embodiment, where the processing is performed for reading data from the external recording medium (DVD).

FIG. 9 shows an example relationship between position information and group information, and an encryption key used for encrypting data that is to be recorded onto the external recording medium (DVD) according to the first embodiment.

FIG. 10 shows an example internal processing configuration of an MFP according to a second embodiment of the present invention.

FIG. 11 shows an example configuration of a core unit according to the second embodiment.

FIG. 12 is a flowchart showing processing performed by a position-control server and the MFP according to the second embodiment.

FIG. 13 is a flowchart illustrating example processing performed by the position-control server and the MFP according to the second embodiment, where the processing is performed for writing data onto the external recording medium (DVD) in the case where the movement of the MFP is detected.

FIG. 14 is a flowchart illustrating example processing performed by the position-control server and the MFP according to the second embodiment, where the processing is performed for reading the data written in the external recording medium (DVD).

FIG. 15 shows an example relationship between position information and group information, and an encryption key used for encrypting data that is to be recorded onto the external recording medium (DVD) according to the second embodiment.

### DESCRIPTION OF THE EMBODIMENTS

### First Embodiment

Next, a first embodiment of the present invention will be described with reference to the attached drawings.

[Exemplary Configuration of System]

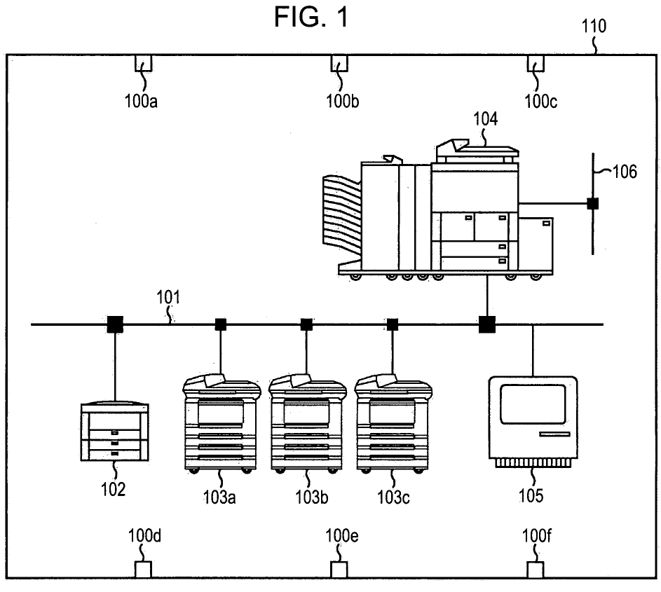

FIG. 1 shows an example configuration of an image forming system according to the first embodiment. As shown in this drawing, the system includes apparatuses provided in a clean room 110. When data is encrypted by the apparatuses and stored in a mobile external recording medium such as a digital versatile disk (DVD), the encrypted data can be decrypted only by the apparatuses provided in the clean room 110.

In FIG. 1, multi-purpose network apparatuses 103a, 103b, 103c, and 104 are connected to a network 101. Additionally, multi-purpose network apparatus 104 is connected to a phone line 106. Each of the network apparatuses 103a, 103b, 103c, and 104 is referred to as a multi function peripheral (MFP). The MFP 104 is a monochrome MFP that can scan and print data in monochrome. Each of the MFPs 103a, 103b, and 103c is a color MFP that can scan and print data in full color.

FIG. 1 also shows a data storage device (hard disk) 102 configured to store data. The data storage device 102 is connected to the network 101 by using an iSCSI protocol. The iSCSI protocol is used for transmitting and receiving a Small Computer System Interface (SCSI) command used for performing communications between a storage unit and a computer via an IP network. The iSCSI protocol allows connecting a large-capacity storage unit such as a hard disk directly to a Transmission Control Protocol/Internet Protocol (TCP/IP) network such as an intra-company local area network (LAN) so that at least two computers can share the storage unit.

The data storage device 102 holds (stores) various data items transmitted thereto via the network 101 by using the above-described iSCSI protocol. Each of position acquisition terminals 100a, 100b, 100c, 100d, 100e, and 100f is configured to transmit position information in the clean room 110 to the MFPs 103a, 103b, 103c and 104 by wireless proximity communications. Here, the position information denotes, for example, the floor information of the clean room 110, and information about the latitude and longitude of the positions where the position acquisition terminals 100a to 100f exist.

A position-control server 105 is a server computer configured to convert the position information transmitted from the MFPs 103a, 103b, 103c and 104 thereto into group information by using a position/group-exchange table and transmit the group information to the MFPs 103a, 103b, 103c and 104. Here, the group information indicates the apparatuses provided in the clean room 110. Thus, in the first embodiment, the group information corresponds to area information.

[Configuration of an MFP]

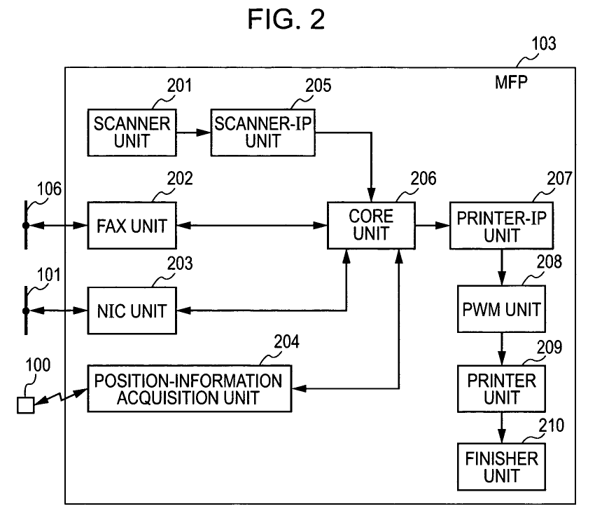

Next, the internal processing configuration of any one of the MFPs 103a, 103b, 103c and 104 will be described, with reference to FIG. 2.

The difference between the MFP 104 and the MFPs 103a to 103c is that the former is provided, as the monochrome MFP and the latter are formed, as the full-color MFPs. Since the full-color MFPs perform the same processing as that of the monochrome MFP except color processing, the functional configuration of any one of the full-color MFPs 103a to 103c will be described, though part of the functional configuration of the monochrome MFP 104 will be provided, as required.

FIG. 2 shows a scanner unit 201 configured to read an image and acquire data on the image, a scanner-IP unit (RGB-IP unit) 205 configured to perform image processing for the image data, and a FAX unit 202 configured to transmit and/or receive image data via the phone line 106. The FAX unit 202 may be provided, as a facsimile machine.

FIG. 2 also shows a network interface card (NIC) unit 203 for transmitting and/or receiving the image data and unit information via the network 101, and a core unit 206 configured to temporarily store the image data according to the usage of the MFPs 103a, 103b, 103c and 104 and determine the processing path of the image data.

The image data transmitted from the core unit 206 is transmitted to a printer-IP (CMYK-IP) unit 207. In the case of the monochrome MFP 104, monochrome image data is transmitted from the core unit 206 to the printer-IP unit 207. In the case of the full-color MFPs 103a to 103c, data on an image of four colors including cyan (C), magenta (M), yellow (Y), and black (K) is transmitted to the printer-IP (CMYK-IP) unit 207. The image data transferred to the printer-IP unit 207 is transmitted to a PWM (pulse width modulation) unit 208, further transmitted to a printer unit 209 that generates an image on a sheet, and printed by a finisher unit 210 configured to perform output finishing processing for the sheet.

A position-information acquisition unit 204 acquires the position information from one of the position acquisition terminals 100a to 100f, the one being closest to the position-information acquisition unit 204, via a wireless interface (I/F) and transmits the position information to the core unit 206.

[Description of Core Unit]

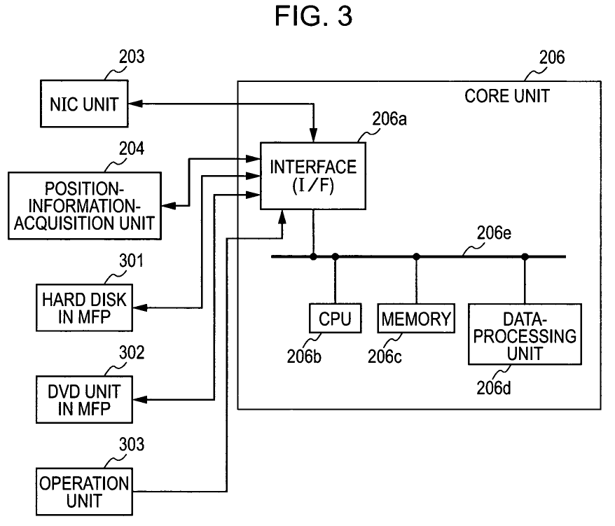

FIG. 3 is a block diagram illustrating an example configuration of the core unit 206.

In FIG. 3, the core unit 206 includes an interface (I/F) 206a, a central processing unit (CPU) 206b, a memory 206c, and a data processing unit 206d that are connected to one another via a bus 206e.

The core unit 206 is connected to the NIC unit 203, the position-information acquisition unit 204, a hard disk in MFP 301, a DVD unit in MFP 302, and an operation unit 303 via the interface 206a. Although not shown in FIG. 3, the scanner unit 201 and the FAX unit 202 shown in FIG. 2 are connected to the core unit 206 via the interface 206a.

The image data transmitted to the core unit 206 is transferred to the data processing unit 206d via the interface 206a. Further, a control command is transferred to the CPU 206b in parallel with the above-described image data transfer. The data processing unit 206d performs image processing including image rotation processing, image scaling processing, and so forth. The image data transferred to the data processing unit 206d is transferred to the hard disk in MFP 301, the DVD unit in MFP 302, and so forth via the interface 206a according to the control command that is transferred simultaneously with the image data.

Upon receiving a print request command that is transmitted from the operation unit 303 operated by a user, the CPU 206b transfers the image data to the data processing unit 206d. The transferred image data is further transferred to the printer-IP unit 207 via the interface 206a. After that, the printer unit 209 forms an image on the sheet, based on the image data, and the finisher unit 210 performs output finishing processing such as the stapling, punching, and so forth. Thus, the image on the basis of the image data is printed.

While the above-described processing is performed, the CPU 206b checks the status of the printer unit 209, as required, and transmits information about the print status to the position-information acquisition unit 204 and the operation unit 303 via the interface 206a. The CPU 206b performs the above-described control processing according to a control program stored in the memory 206c and the control command transferred via the interface 206a. The memory 206c is also used, as a work area of the CPU 206b.

Thus, the core unit 206 controls the flow of the transferred data and performs processing of mixed functions including reading an original image, printing the image, and transmitting and/or receiving data between the core unit 206 and the computer.

[Interrelationship Between Position-Control Server and MFP]

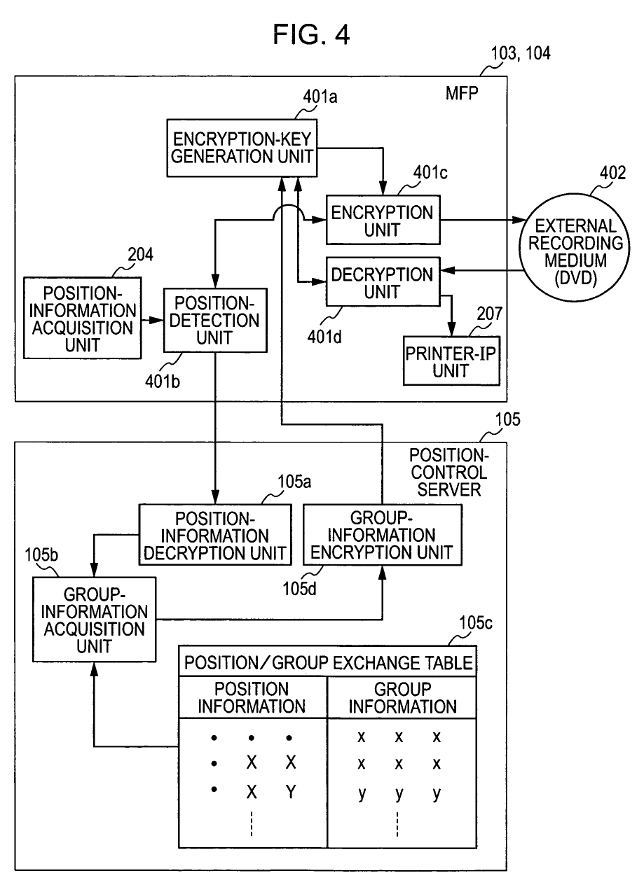

FIG. 4 is a block diagram showing an example functional configuration of the position-control server 105 and any one of the MFPs 103a, 103b, 103c and 104. The configuration shown in FIG. 4 corresponds to part where any one of the MFPs 103a, 103b, 103c and 104 communicates with the position-control server 105 and reads or writes data from or to the external recording medium 402.

The position-information acquisition unit 204 acquires the position information by wireless communications from at least one of the position acquisition terminals 100a to 100f and decoded by a position-detection unit 401b. Then, the position information is encrypted by using a common key shared by the MFPs 103a, 103b, 103c and 104 and the position-control server 105, and transmitted to the position-control server 105 via the network 101. It is noted that the common key may be a key used in a symmetric key cryptosystem.

Upon receiving the encrypted position information, a position-information decryption unit 105a of the position-control server 105 decrypts the transmitted position information by using the common key. A group-information acquisition unit 105b converts the decrypted position information into the group information by using the position/group exchange table 105c. A group-information encryption unit 105d encrypts the group information by using the common key. The encrypted group information is transferred to any one of the MFPs 103a, 103b, 103c and 104.

When the group information transmitted from the position-control server 105 is decrypted, an encryption-key generation unit 401a of any one of the MFPs 103, 103b, 103c and 104 generates an encryption key based on the decrypted group information. At that time, the encryption-key generation unit 401a generates the encryption key so that one-to-one correspondence is established between the group information and the encryption key.

The encryption unit 401c encrypts input data by using the encryption key generated by the encryption-key generation unit 401a and writes the encrypted data to an external recording medium (such as a DVD) 402. A decryption unit 401d decrypts the data read from the external recording medium 402 and transmits the decrypted data to the printer-IP unit 207.

The above-described processing performed in the blocks shown in FIG. 4 is achieved by a computer system including a CPU, a random access memory (RAM), and a read-only memory (ROM) (the CPU 206b and the memory 206c in the case of the MFPs 103a, 103b, 103c and 104).

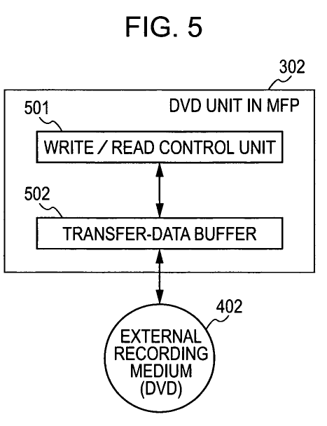

The DVD unit in MFP 302 configured to read or write data from or to the external recording medium (DVD) 402 will be described next. FIG. 5 shows an example functional configuration of the DVD unit in MFP 302.

In FIG. 5, the DVD unit in MFP 302 writes and/or reads data under the control of a write/read control unit 501. Where the DVD unit in MFP 302 writes and/or reads data, the data is temporarily stored in a transfer-data buffer 502, so as to absorb the difference between the speed of transmitting data from the outside to the DVD unit in MFP 302 and the speed of externally transmitting data from the DVD unit in MFP 302. Namely, data is written to the external recording medium (DVD) 402 via the transfer-data buffer 502.

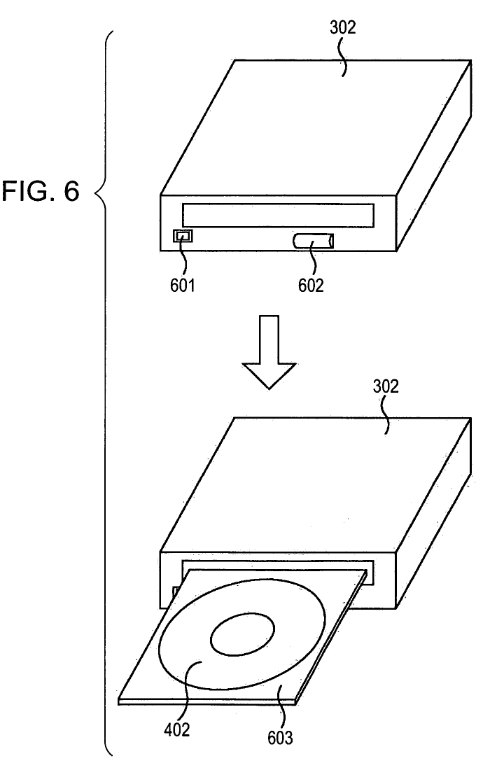

FIG. 6 shows an example configuration of the DVD unit in MFP 302.

As shown in FIG. 6, a tray 603 is provided for inserting the external recording medium (DVD) 402 in a predetermined operation position of the DVD unit in MFP 302. An eject button 602 is operated by the user, so as to insert or eject the external recording medium (DVD) 402 accommodated by the tray 603. Further, the DVD unit in MFP 302 of the first embodiment includes an access lamp 601 that lights up, so as to inform the user of the state of reading and/or writing data.

[Processing Performed by Position-Control Server and MFP]

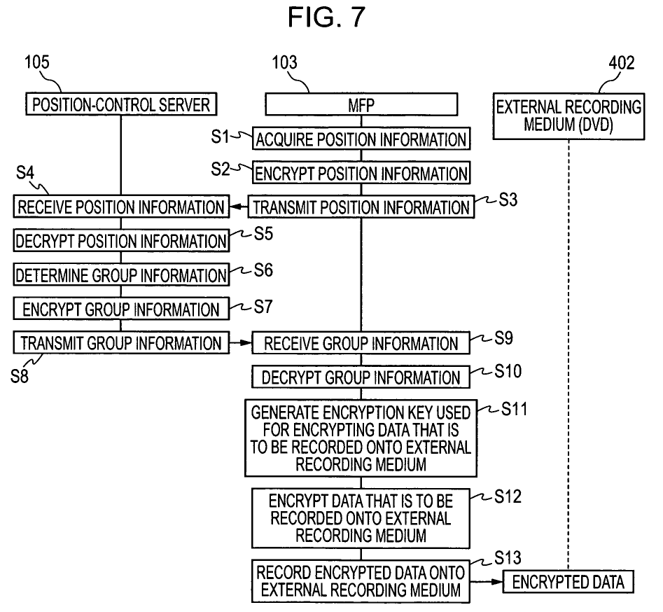

FIG. 7 is a flowchart illustrating example processing performed by the position-control server 105 and the MFPs 103a, 103b, 103c and 104. The processing is performed for writing data onto the external recording medium (e.g., DVD) 402. In the following description, the MFP 104 operates in the same way as is the case with the MFP 103a to 103c.

First, when the user transmits a data-record instruction to the position-information acquisition unit 204 of any one of the MFPs 103a to 103c (hereinafter referred to as the MFP 103) by operating the operation unit 303, the position-information acquisition unit 204 acquires the position information from the position acquisition terminals 100a to 100f, at step S1. Further, the position-detection unit 401b interprets the position information acquired by the position-information acquisition unit 204.

Then, the encryption unit 401c encrypts the position information interpreted by the position-detection unit 401b by using the common key shared by the MFP 103 and the position-control server 105, at step S2.

Next, the MFP 103 transmits the encrypted position information to the position-control server 105 via the interface 206a and the network 101, at step S3.

Next, when the position-control server 105 receives the encrypted position information, at step S4, the position-information decryption unit 105a decrypts the received position information by using the common key, at step S5.

Next, the group-information acquisition unit 105b converts the decrypted position information into group information by using the position/group-exchange table 105c, at step S6.

Next, the group-information encryption unit 105d encrypts the group information by using the common key, at step S7. Then, the position-control server 105 transmits the encrypted group information to the MFP 103, at step S8.

Then, when the MFP 103 receives the encrypted group information, at step S9, the encryption-key generation unit 401a of the MFP 103 transmits an instruction for decrypting the received group information to the decryption unit 401d, at step S10. Subsequently, the decryption unit 401d decrypts the group information by using the common key.

Next, the encryption-key generation unit 401a generates an encryption key for encrypting data that is to be recorded onto the external recording medium (DVD) 402 based on the decrypted group information, at step S11.

Next, the encryption unit 401c encrypts the data by using the encryption key generated by the encryption-key generation unit 401a, at step S12, and the encryption unit 401c writes the encrypted data onto the external recording medium (DVD) 402, at step S13. After that, the encryption unit 401c cancels the encryption key used for the above-described encryption.

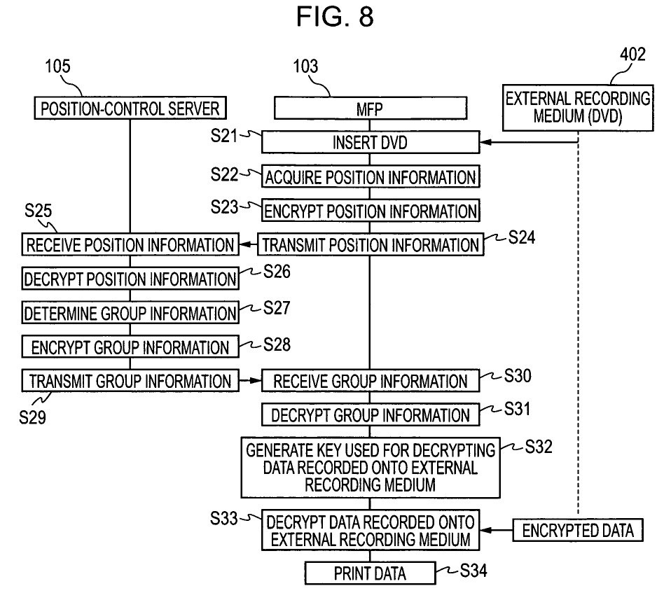

FIG. 8 is a flowchart illustrating example processing performed by the position-control server 105 and the MFPs 103a, 103b, 103c and 104. The processing is performed, so as to read data written in the external recording medium (DVD) 402. In the following description, the MFP 104 operates in the same way as is the case with the MFPs 103a to 103c.

First, the DVD unit 302 provided in the MFP 103 detects that the insertion of the external recording medium (DVD) 402 and the user transmits a data-reproduction instruction by operating the operation unit 303 provided in the MFP 103, at step S21, the MFP 103 performs the same processing as the processing corresponding to steps S1 to S11 shown in FIG. 7, at steps S22 to S32. Namely, the MFP 103 acquires the position information, encrypts the acquired position information, and transmits the encrypted position information to the position-control server 105, at steps S22 to S24. Then, the position-control server 105 decrypts the transmitted position information, converts the decrypted position information into the group information, encrypts the converted group information, and transmits the encrypted group information to the MFP 103, at steps S25 to S29. Upon receiving the group information, the MFP 103 decrypts the group information and generates a key used for decrypting the data stored in the external recording medium (DVD) 402, based on the decrypted group information, at steps S30 to S32.

Then, at step S33, the decryption unit 401d of the MFP 103 reads the data from the external recording medium (DVD) 402 and decrypts the read data by using the key generated, at step S30. If the read data is decrypted, it means that the key generated, at step S30, is the same as the encryption key generated, at step S11 shown in FIG. 7. After that, the decryption unit 401d cancels the key used for the above-described decryption.

Finally, the printer unit 209 and the finisher unit 210 of the MFP 103 print the decrypted data, at step S34.

[Relationship Between Position Information and Group Information, and Encryption Key]

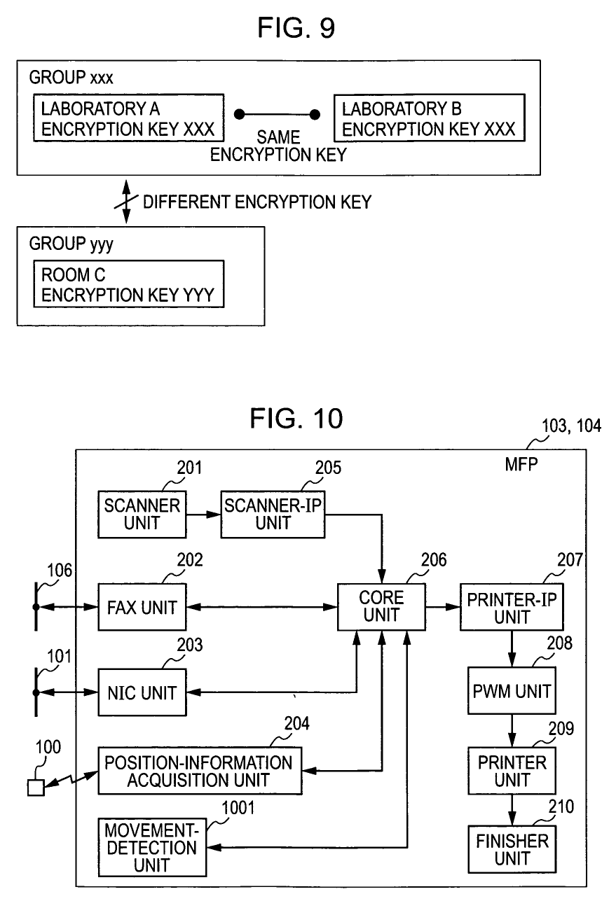

FIG. 9 shows an example relationship between the position information and the group information, and the encryption key used for encrypting data that is to be recorded onto the external recording medium (DVD) 402. As shown in FIG. 9, even though first position information (e.g., laboratory A) and second position information (e.g., laboratory B) are different, data that is to be written into the external recording medium (DVD) 402 is encrypted by using the same encryption key XXX when group information corresponding to the first position information and group information corresponding to the second position information have a same value (e.g., xxx). On the other hand, if the group information has a different value (e.g., yyy), the data that is to be written into the external recording medium (DVD) 402 is encrypted by using an encryption key YYY that is different from the encryption key XXX.

Thus, according to the first embodiment, each of the MFPs 103a, 103b, 103c and 104 generates the encryption key used for encrypting data that is to be stored in the external recording medium (DVD) 402 based on the group information acquired from the position-control server 105, encrypts the data by using the encryption key, and stores the encrypted data in the external recording medium (DVD) 402. After that, when reading the data stored in the external recording medium (DVD) 402, each of the MFPs 103a, 103b, 103c and 104 acquires the group information by performing the same processing as that performed for writing the data onto the external recording medium (DVD) 402 and generates a key used for decrypting the data stored in the external recording medium (DVD) 402 based on the acquired group information.

Therefore, unless the group information acquired at the time where the data stored in the external recording medium (DVD) 402 is read agrees with the group information acquired at the time where the data is stored in the external recording medium (DVD) 402, the same key as the encryption key cannot be generated at the time that the data stored in the external recording medium (DVD) 402 is read and the data stored in the external recording medium (DVD) 402 cannot be decrypted. Namely, data encrypted by the MFPs 103a, 103b, 103c and 104 in the clean room 110 can be decrypted and reproduced only by the MFPs 103a, 103b, 103c and 104.

Subsequently, the data stored in the external recording medium (DVD) 402 can be reproduced only in the clean room 110. Further, since the encryption key is controlled only in the MFPs 103a, 103b, 103c and 104, the user does not have to worry about the encryption key. Further, since the encryption key is kept inside the MFPs 103a, 103b, 103c and 104, the convenience and safety of the image forming system increase.

Thus, according to the first embodiment, the position information is converted into the group information by the position-control server 105 and the encryption key and the decryption key are generated based on the converted group information, so as to ensure the safety of a predetermined area such as the clean room 110 of the first embodiment. However, in another embodiment, the encryption key may be generated based on the position information instead of converting the position information into the group information.

Further, even though the DVD is used in the first embodiment, as an example mobile external recording medium, a magneto-optical (MO) disk or the like can also be used in the first embodiment.

### Second Embodiment

Next, a second embodiment of the present invention will be described. According to the first embodiment, the group information is acquired from the position-control server 105 and the decryption key used for decrypting data is generated based on the acquired group information so that the decryption key is used for reading the data. However, according to the second embodiment, the encryption key used for the data encryption is held, which eliminates the need to generate a new key for reading the data until the MFPs 103a, 103b, 103c and 104 detect the movement thereof. Thus, the second embodiment is the same as the first embodiment except part of the processing performed for reading and/or writing the data. Therefore, the same parts as those of the first embodiment will be designated by the same reference numerals as those shown in FIGS. 1 to 9 (described above with reference to the first embodiment) and the description thereof is omitted.

[Configuration of MFP]

FIG. 10 is a block diagram illustrating an example internal processing configuration of the MFPs 103a, 103b, 103c and 104 (hereinafter referred to as the MFP) provided in the same system as the image forming system shown in FIG. 1. The configuration of the MFP according to the second embodiment is the same as that of MFP according to the first embodiment except the addition of a movement-detection unit 1001.

The movement-detection unit 1001 includes a sensor configured to detect the movement of the MFP 103a, 103b, 103c and 104 and a memory configured to store the movement status. In the second embodiment, the sensor detects the movement of the MFP 103a, 103b, 103c and 104 by using an infrared ray, a microwave, and so forth. The above-described sensor can be supplied with power by a battery even though the power of the main body of the MFP is turned off so that the sensor can continually detect the movement and/or stopping of the MFP 103a, 103b, 103c and 104.

[Configuration of Core Unit]

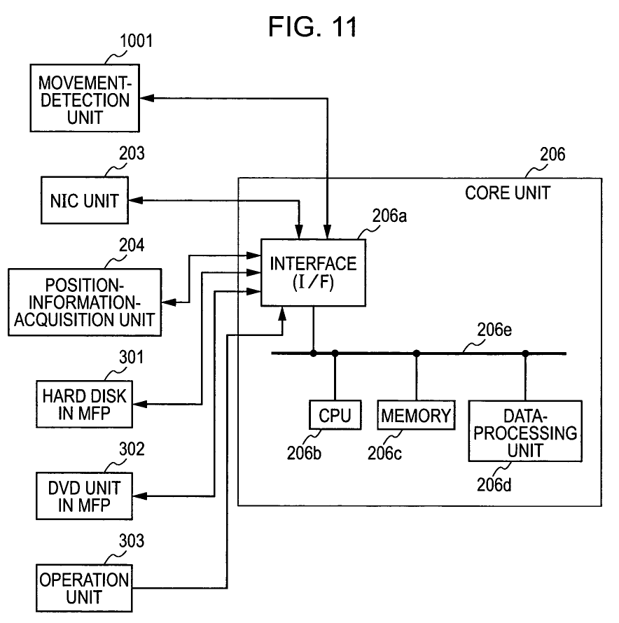

FIG. 11 is a block diagram illustrating an example configuration of the core unit 206. As shown in this drawing, the configuration of the core unit 206 of the second embodiment is the same as that shown in FIG. 3 of the first embodiment except that the movement-detection unit 1001 is provided, as described above. Therefore, the core unit 206 of the second embodiment processes a signal transmitted from the movement-detection unit 1001.

The CPU 206b communicates with the movement-detection unit 1001 via the bus 206e and the interface unit 206a, and acquires information about the movement and stopping of the MFP 103a, 103b, 103c and 104. Since the movement-detection unit 1001 is continually supplied with power by the battery, as described above, the movement-detection unit 1001 can monitor the state of the main body of the MFP and store information about the monitored state in a memory provided therein, even though the power of the main body of the MFP 103a, 103b, 103c and 104 is turned off, that is, the power of the core unit 206 is turned off. Subsequently, the CPU 206b can acquire the state information accumulated in the memory after the main body of the MFP is started. Therefore, even though the MFP 103a, 103b, 103c and 104 moves while the power of the main body of the MFP is off, the CPU 206b can be informed of the movement.

[Processing Performed by Position-Control Server and MFP]

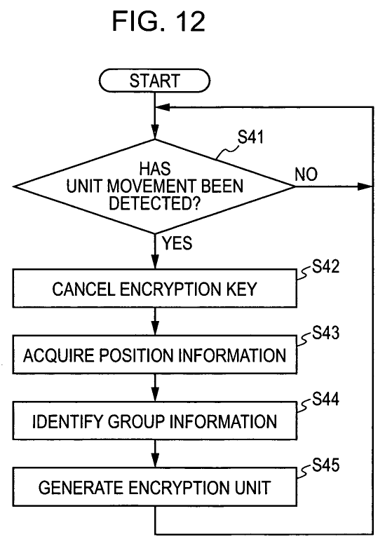

FIG. 12 is a flowchart showing processing performed by the position-control server 105 and the MFPs 103a, 103b, 103c and 104. In the following description, the MFPs 103a, 103b, 103c and 104 will be referred to as the MFP 103, since the MFP 104 operates in the same way as is the case with the MFP 103a to 103c.

First, the movement-detection unit 1001 checks for movement of the MFP 103 at step S41. If the movement-detection unit 1001 does not detect the movement of the MFP 103, the encryption key is held as it is. If the movement-detection unit 1001 detects movement of the MFP 103, the MFP 103 cancels the stored encryption key at step S42.

Then, the MFP 103 acquires the position information from the position-information acquisition terminals 100a to 10f, as is the case with the first embodiment, at step S43.

Next, the MFP 103 encrypts the acquired position information and transmits the encrypted position information to the position-control server 105, as is the case with the first embodiment, at step S44. The position-control server 105 converts the transmitted position information into the group information, encrypts the converted group information, and transmits the encrypted group information to the MFP 103, as is the case with the first embodiment.

Finally, at step S45, the MFP 103 decrypts the transmitted group information and generates a new encryption key based on the decrypted group information, at step S45, as is the case with the first embodiment. The processing shown in FIG. 12 is continuously repeated while the MFP 103 is turned on.

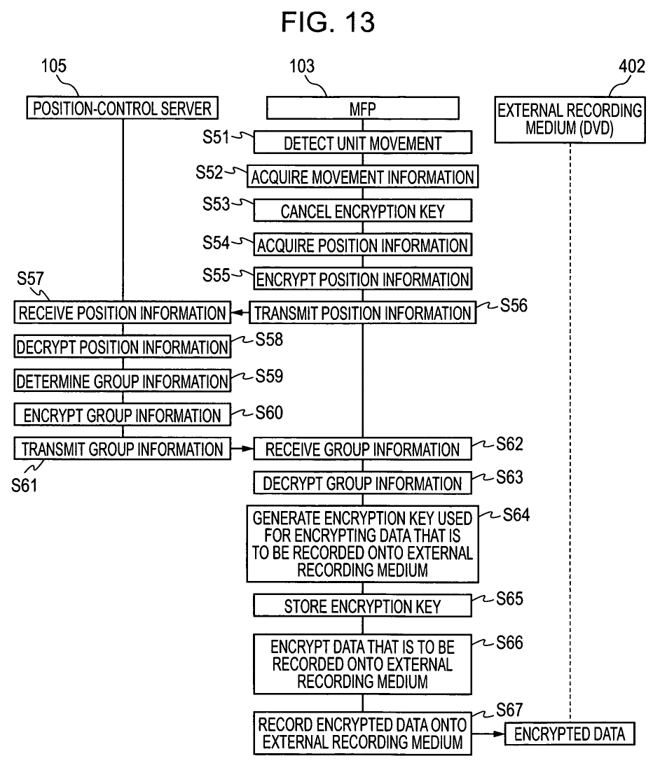

FIG. 13 is a flowchart illustrating example processing performed by the position-control server 105 and the MFPs 103a, 103b, 103c and 104, so as to write data onto the external recording medium (DVD), where the movement of the MFPs 103a, 103b, 103c and 104 is detected. In the following description, the MFPs 103a, 103b, 103c and 104 will be referred to as the MFP 103, since the MFP 104 operates in the same way as is the case with the MFP 103a to 103c.

First, when the movement-detection unit 1001 detects the movement of the MFP 103 by using the sensor, at step S51, the CPU 206b of the MFP 103 acquires the movement information from the movement-detection unit 1001, at step S52.

Next, the MFP 103 cancels the stored encryption key, at step S53. More specifically, the MFP 103 rewrites invalid data into a save area of the encryption key, for example.

Next, the MFP 103 performs the same processing as the processing corresponding to steps S1 to S11 shown in FIG. 7, at steps S54 to S64. Namely, the MFP 103 acquires the position information, encrypts the acquired position information, and transmits the encrypted position information to the position-control server 105, at steps S54 to S56. Then, the position-control server 105 decrypts the transmitted position information, converts the decrypted position information into the group information, encrypts the converted group information, and transmits the encrypted group information to the MFP 103, at steps S57 to S61. Upon receiving the group information, the MFP 103 decrypts the group information and generates a new encryption key used for storing data in the external recording medium (DVD) 402 based on the decrypted group information, at steps S62 to S64.

Then, the MFP 103 stores the newly generated encryption key, at step S65. Further, the MFP 103 encrypts the data by using the newly generated encryption key, at step S66, and writes the encrypted data onto the external recording medium (DVD) 402, at step S67.

If the movement-detection unit 1001 does not detect the movement of the MFP 103, the processing corresponding to steps S52 to S65 is not performed. In that case, the MFP 103 encrypts the data by using the currently stored encryption key, at step S66, and writes the encrypted data into the external recording medium (DVD) 402, at step S67.

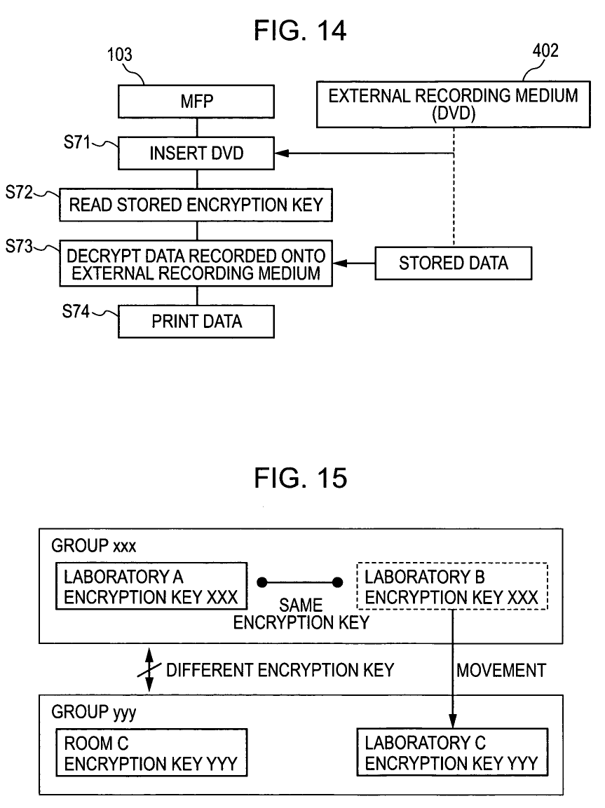

FIG. 14 is a flowchart illustrating example processing performed by the position-control server 105 and the MFPs 103a, 103b, 103c and 104. The processing is performed, so as to read data written in the external recording medium (DVD) 402. In the following description, the MFPs 103a, 103b, 103c and 104 are referred to as the MFP 103, since the MFP 104 operates in the same way as is the case with the MFPs 103a to 103c.

First, the DVD unit 402 provided in the MFP 103 detects the insertion of the external recording medium (DVD) 402, at step S71, the MFP 103 reads the stored encryption key, at step S72. Then, at step S73, the MFP 103 reads the data from the external recording medium (DVD) 402 and decrypts the read data by using the encryption key that had been read, at step S72. Finally, the MFP 103 prints the decrypted data, at step S74.

[Relationship Among Position Information, Group Information, and Encryption key]

FIG. 15 shows example relationship between the position information and the group information, and the encryption key used for encrypting data that is to be recorded onto the external recording medium (DVD) 402. As shown in FIG. 15, even though first position information (e.g., laboratory A) and second position information (e.g., laboratory B) are different, the data that is to be written into the external recording medium (DVD) 402 is encrypted by using the same encryption key XXX when group information corresponding to the first position information and group information corresponding to the second position information have a same value (e.g., xxx). On the other hand, if the group information has a different value (e.g., yyy), the data that is to be written into the external recording medium (DVD) 402 is encrypted by using an encryption key YYY that is different from the encryption key XXX.

If the movement of the MFP 103 is detected, that is to say, if the movement from the laboratory B to a laboratory C is detected, the encryption key XXX is canceled and the encryption key YYY is newly generated according to the group information yyy that corresponds to the position (the laboratory C) where the MFP 103 is provided.

Thus, according to the second embodiment, the MFP 103 holds the encryption key used for encrypting data that is to be stored in the external recording medium (DVD) 402, the stored encryption key is cancelled when the movement of the MFP 103 is detected, and a new encryption key suitable for the destination to which the MFP 103 moved is generated and held, as is the case with the first embodiment. If no movement of the MFP 103 is detected, the encryption key is held as it is. For decrypting the data stored in the external recording medium (DVD) 402, the currently stored encryption key is used. Therefore, when the MFP 103 is moved out of the clean room 110 due to the layout change or the like, the MFP 103 cannot decrypt data encrypted by itself, namely, the MFP 103 in the clean room 110. Subsequently, the convenience and safety of the system increase, as in the first embodiment of the present invention.

Further, according to the second embodiment, for storing data in the external recording medium (DVD) 402 when no movement is detected, there is no need to acquire the group information from the position-control server 105. Further, for reading the data stored in the external recording medium (DVD) 402, there is no need to acquire the group information from the position-control server 105. Subsequently, it becomes possible to reduce access to the position-control server 105 as much as possible, which makes the processing speed higher than that of the first embodiment.

### Other Embodiments

It is to be understood that program code (software) for implementing the functions of the above-described embodiments may be supplied to a computer provided in an apparatus or system connected to various devices so that the various devices operate for achieving the functions of the above-described embodiments and making the various devices operate according to a program stored in the computer (CPU or micro-processing unit (MPU)) of the system or the apparatus.

In that case, the program code itself achieves the functions of the above-described embodiments. The recording medium storing the program code may be, for example, a flexible disk, a hard disk, an optical disk, a magneto-optical disk, a compact disk-read-only memory (CD-ROM), a magnetic tape, a non-volatile memory card, a ROM, and so forth.

Furthermore, not only by the computer executing the supplied program code, but also by the computer executing the program code utilizing an operating system (OS), application software, etc. running on the computer, the functions of the above-described embodiments may be achieved.

In another embodiment of the present invention, the supplied program code may be stored in a memory of a function extension board inserted in the computer or a function extension unit connected to the computer. The functions of the above-described embodiments may be realized by executing part of or the entire process by a CPU, etc. of the function extension board or the function extension unit based on instructions of the program code.

According to the present invention, data encrypted by using a key generated based on position information of a data processing apparatus is stored in an external recording medium so that the data processing apparatus can decrypt the data stored in the external recording medium only when the data processing apparatus can acquire the key generated based on the position information. Subsequently, it becomes possible to limit the place where the data stored in the external recording medium is reproduced, with maximum reliability.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims the benefit of Japanese Application No. 2004-266822 filed on Sep. 14, 2004, which is hereby incorporated by reference herein in its entirety.

What is claimed is:

1. A data processing apparatus comprising:
a position-information acquisition unit adapted to acquire position information of the data processing apparatus;
a key-generation unit adapted to generate a key dependent on the position information acquired by the position-information acquisition unit;
an encryption unit adapted to generate encrypted data by encrypting data by using the key generated by the key-generation unit;
a recording unit adapted to record the encrypted data onto an external recording medium; and
a decryption unit adapted to decrypt the encrypted data recorded onto the external recording medium by using a key that is dependent on the position information acquired by the position-information acquisition unit and that is generated by the key-generation unit.

2. A data processing apparatus according to claim 1, further comprising:
a position-information transmission unit adapted to transmit the position information acquired by the position-information acquisition unit to a position-control apparatus configured to control area information corresponding to the position of the data processing apparatus; and
an area-information acquisition unit adapted to acquire the area information corresponding to the position information transmitted from the position-information transmission unit to the position-control apparatus,
wherein the key-generation unit is adapted to generate the key by using the area information acquired by the area-information acquisition unit.

3. A data processing apparatus according to claim 2, wherein the area-information acquisition unit is adapted to acquire the area information encrypted by using a shared key that is shared by the position-control apparatus and the data processing apparatus, the decryption unit is adapted to decrypt the area information acquired by the area-information acquisition unit by using the shared key, and the key-generation unit is adapted to generate the key by using the area information decrypted by the decryption unit.

4. A data processing apparatus according to claim 1, wherein the position-information acquisition unit is adapted to acquire the position information to encrypt and/or decrypt the data.

5. A data processing apparatus according to claim 1, further comprising a key-cancel unit adapted to cancel the key used by the encryption unit and/or the decryption unit.

6. A data processing apparatus according to claim 1, further comprising:
a key-hold unit adapted to hold the key generated by the key-generation unit; and
a movement-detection unit adapted to detect movement of the data processing apparatus,
wherein after the movement-detection unit detects movement of the data processing apparatus, the position-information acquisition unit acquires the position information.

7. A data processing apparatus according to claim 6, wherein the key-hold unit is adapted to hold the newest key generated by the key-generation unit.

8. A data processing apparatus according to claim 6, further comprising a key-erase unit adapted to erase the key held in the key-hold unit after the movement-detection unit detects movement of the data processing apparatus.

9. A data processing method comprising steps of:
receiving a record instruction for recording data onto an external recording medium;
acquiring first position information of a data processing apparatus based on the record instruction;
generating a first key dependent on the first position information;
generating encrypted data by encrypting the data using the first key;
recording the encrypted data onto the external recording medium;
receiving a reproduction instruction for reproducing the encrypted data recorded onto the external recording medium;
acquiring second position information of the data processing apparatus based on the reproduction instruction;
generating a second key dependent on the second position information; and
decrypting the encrypted data recorded onto the external recording medium using the second key.

10. A data processing method according to claim 9, further comprising steps of:
transmitting the first position information to a position-control apparatus configured to control area information corresponding to at least one position of the data processing apparatus;
transmitting the second position information to the position-control apparatus;
acquiring first area information corresponding to the first position information from the position-control apparatus; and
acquiring second area information corresponding to the second position information from the position-control apparatus,
wherein the first key is generated using the first area information acquired from the position-control apparatus and the second key is generated using the second area information acquired from the position-control apparatus.

11. A data processing method according to claim 10, further comprising steps of:
decrypting the first area information by using a shared key shared by the position-control apparatus and the data processing apparatus; and
decrypting the second area information by using the shared key,
wherein the first key is generated by using the first area information that was decrypted, and the second key is generated by using the second area information that was decrypted.

12. A data processing method according to claim 11, further comprising a step of:
canceling the first key used for encrypting the data.

13. A data processing method according to claim 10, further comprising a step of:
canceling the first key used for encrypting the data.

14. A data processing method according to claim 9, further comprising a step of:
canceling the first key used for encrypting the data.

15. A computer program configured to make a computer execute a data processing method according to claim 9.

16. A data processing method comprising steps of:
detecting movement of a data processing apparatus;
acquiring position information of the data processing apparatus after movement of the data processing apparatus is detected;
generating a key dependent on the position information;
holding the key;
generating encrypted data by encrypting data using the key;
recording the encrypted data onto an external recording medium; and
decrypting the encrypted data recorded onto the external recording medium by using the key that was held.

17. A data processing method according to claim 16, further comprising steps of:
transmitting the position information to a position-control apparatus configured to control position of the data processing apparatus; and
acquiring area information corresponding to the position information transmitted from the position-control apparatus,
wherein the key is generated using the area information.

18. A data processing method according to claim 17, further comprising a step of decrypting the area information using a shared key shared by the position-control apparatus and the data processing apparatus,
wherein the shared key is generated using the area information that was decrypted.

19. A data processing method according to claim 18, wherein the newest key is held.

20. A data processing method according to claim 17, wherein the newest key is held.

21. A data processing method according to claim 16, wherein the newest key is held.

22. A data processing method according to claim 16, further comprising a step of erasing the key that was held before movement of the data processing apparatus is detected after movement of the data processing apparatus is detected.

23. A computer program configured to make a computer execute a data processing method according to claim 16.
